(19) United States
(12) Patent Application Publication
(10) Pub. No.: US 2026/0118117 A1
(43) Pub. Date: Apr. 30, 2026

(54) CHARGED PARTICLE EVALUATION SYSTEM AND METHOD FOR ALIGNING MEASUREMENTS

(71) Applicant: Applied Materials Israel Ltd., Rehovot (IL)

(72) Inventors: Idan Tamir, Rehovot (IL); Gadi Oron, Rehovot (IL); Shmuel Mizrachi, Rehovot (IL); John Breuer, Heimstetten (DE); Dominik Patrick Ehberger, Heimstetten (DE)

(73) Assignee: Applied Materials Israel Ltd., Rehovot (IL)

(21) Appl. No.: 18/930,177

(22) Filed: Oct. 29, 2024

(51) Int. Cl. G01B 15/00

(52) U.S. Cl. CPC G01B 15/00

(57) ABSTRACT

A charged particle evaluation system that includes (a) a controller; (b) a charged particle emitter configured to emit charged particles that exhibit a charged particle emitter energy spread; and (c) optics that is configured to perform evaluations of a sample, and to measure the charged particle emitter energy spread. The controller is configured to set the charged particle emitter energy spread to a shared charged particle emitter energy spread that is shared between a group of charged particle evaluation systems.

### BACKGROUND OF THE INVENTION

Critical dimension measurement systems include an electron emitter that emits charged particles that form an electron beam that impinges on a sample.

The size and shape of the electron beam's spot on the sample depend on different aberrations, among which the chromatic aberration that is related to the energy spread of emitted charged particles.

Differences in spot size and shape result in different imaging of the sample.

Different critical dimension measurement systems differ from each other by the electron energy spread of charged particles that form the electron beam.

The difference between the electron energy spread results in different spot sizes and non-aligned critical dimension measurements—as different critical dimension measurement systems will provide different measurement results when measuring exactly the same critical dimensions.

There is a growing need to provide a method for aligning critical dimension measurement generated by different critical dimension measurement systems.

### BRIEF SUMMARY OF THE INVENTION

There is provided a charged particle evaluation system that includes a controller, a charged particle emitter configured to emit charged particles that exhibit a charged particle emitter energy spread; and optics that is configured to perform critical dimension measurement of a sample, and to measure the charged particle emitter energy spread. The controller is configured to set the charged particle emitter energy spread to a shared charged particle emitter energy spread that is shared between a group of charged particle evaluation systems.

There is provided a method for improving critical dimension measurements matching, the method includes measuring a charged particle emitter energy spread, using optics of a charged particle evaluation system; and setting the charged particle emitted energy spread to a shared charged particle emitter energy spread that is shared between a group of charged particle evaluation systems.

There is provided a non-transitory computer readable medium for improving critical dimension measurements matching, the non-transitory computer readable medium stores instructions that once executed by a processing circuit of a charged particle evaluation system, causes the charged particle evaluation system to measure a charged particle emitter energy spread, using optics of the charged particle evaluation system; and set the charged particle emitted energy spread to a shared charged particle emitter energy spread that is shared between a group of charged particle evaluation systems.

### BRIEF DESCRIPTION OF THE DRAWINGS

The subject matter regarded as the invention is particularly pointed out and distinctly claimed in the concluding portion of the specification. The invention, however, both as to organization and method of operation, together with specimen s, features, and advantages thereof, may best be understood by reference to the following detailed description when read with the accompanying drawings in which:

FIG. 1 illustrates an example of a critical dimension measurement system;

FIG. 2 illustrates an example of a critical dimension measurement system;

FIG. 3 illustrates an example of a method; and

FIG. 4 illustrates an example of a spectrum.

### DETAILED DESCRIPTION OF THE INVENTION

According to an embodiment there is provided a charged particle evaluation system, a method, and a non-transitory computer readable medium.

A charge particle is an electron or an ion.

A charged particle evaluation system uses one or more charged particle beams form performing an evaluation of a sample. The evaluation may involve defect review, defect detection, metrology, and the like. Critical dimension measurements are an example of metrology.

Non-limiting examples of charged particle evaluation systems includes scanning electron microscopes, charged particle beam imagers, and the like. Scanning electron microscopes include defect review scanning electron microscopes, critical dimension scanning electron microscopes, and the like.

For simplicity of explanation some of the text refers to a critical dimension measurement system, but any reference to a critical dimension measurement system should be applied mutatis mutandis to any other charged particle evaluation system. Any reference to a critical dimension measurement should be applied mutatis mutandis to any other evaluation result—for example to a defect review result, to a defect detection result, and the like.

According to an embodiment there is provided a charged particle evaluation system, a method and a non-transitory computer readable medium that allows to set charged particle energy spreads of charged particle evaluation systems of a group to the same shared value-which provides aligned evaluation results, such as aligned critical dimension measurements results. The aligned evaluation results may be compared to each other, may be used for training a neural network model used for evaluation (for example for determining critical dimensions) and the like.

The charged particle energy spreads of charged particle evaluation systems are measured in-situ, using the same optics that are also used for performing the critical dimension measurements, which makes the suggested solution more accurate, less costly (no need to provide dedicated charged particle energy spread measurement components), and also enables to perform the charged particle energy spread measurement multiple times over the lifespan of the charged particle evaluation systems, instead of only performing such measurement at a critical dimension measurement system manufacturer facilities, before shipping the charged particle evaluation systems to customers.

According to an embodiment, the shared charged particle energy spread value is measured and then is set.

According to an embodiment the minimal charged particle energy spread value may change over time—and the execution of measurements along the lifespan of the charged particle evaluation systems allow to detect this change and define a new shared value of the charged particle energy spread of the members of the group.

According to an embodiment there is provided a charged particle evaluation system that includes a controller, a charged particle emitter configured to emit charged particles that exhibit a charged particle emitter energy spread, and optics that is configured to perform an evaluation of a sample, and to measure the charged particle emitter energy spread.

According to an embodiment, the controller is configured to set the charged particle emitter energy spread to a shared charged particle emitter energy spread that is shared between a group of charged particle evaluation systems.

According to an embodiment, the optics includes a charged particle detector and an energy filter that precedes the charged particle detector, wherein the optics is configured to generate a spectrum of charged particle energies emitted by the charged particle emitter, based on charged particles that were emitted from a sample illuminated by charged particles that exhibit the charged particle emitter energy spread and detected by the charged particle detector.

According to an embodiment, the critical dimension measurement system is configured to generate the spectrum by performing multiple evaluation iterations that differ from each other by a value of an energy filter voltage supplied to the energy filter. The energy filter voltage prevents charged particles having energy that has a lower absolute value that the absolute value of the energy filter voltage to reach the detector.

Scanning values of the energy filter voltage, for example scanning between a maximal value in which all charged particles are rejected to a minimal value, in which all charged particles pass through the energy filter, provides the spectrum.

According to an embodiment, the charged particle evaluation system includes a charged particle emitter bias voltage supplier, wherein the charged particle evaluation system is configured to generate the spectrum by the charged particle emitter, by performing multiple evaluation iterations that differ from each other by a value of a charged particle emitter bias voltage supplied by the charged particle emitter bias voltage supplier. Differences in the charged particle emitter bias voltage are converted to differences in the energy of charged particles emitted from the charged particle emitter. The charged particle evaluation system may include an energy filter for filtering charged particles from reaching the charged particle detector or may not include such an energy filter.

According to an embodiment, the charged particle evaluation system includes a charged particle emitter bias voltage supplier that is configured to set the charged particle emitter energy spread by setting a value of a charged particle emitter energy bias voltage supplied by the charged particle emitter bias voltage supplier.

According to an embodiment, the charged particle evaluation system includes a deflector that is configured to deflect a charged particle beam that comprises charged particles emitted by the charged particle emitter to provide an out of optical axis charged particle beam, wherein the charged particle evaluation system is configured to measure of the charged particle emitter energy spread by acquiring images of a spot formed on the sample by an out of optical axis charged particle beam at different distances between the sample and the charged particle emitter. According to an embodiment, the measurement of the charged particle emitter energy spread includes measuring the numerical aperture of the charged particle beam and deducting the charged particle emitter energy spread based on the numerical aperture. Examples of measuring the numerical aperture of an electron beam are provided in U.S. Pat. No. 11,791,128 and in U.S. Pat. No. 11,810,753, which are incorporated herein by reference.

According to an embodiment, the charged particle evaluation system includes a processing circuit that is configured to perform a three-dimensional reconstruction of a proximal end of the out of optical axis charged particle beam. An example of such a three-dimensional reconstruction is illustrated in U.S. Pat. No. 11,791,128 and in U.S. Pat. No. 11,810,753, which are incorporated herein by reference.

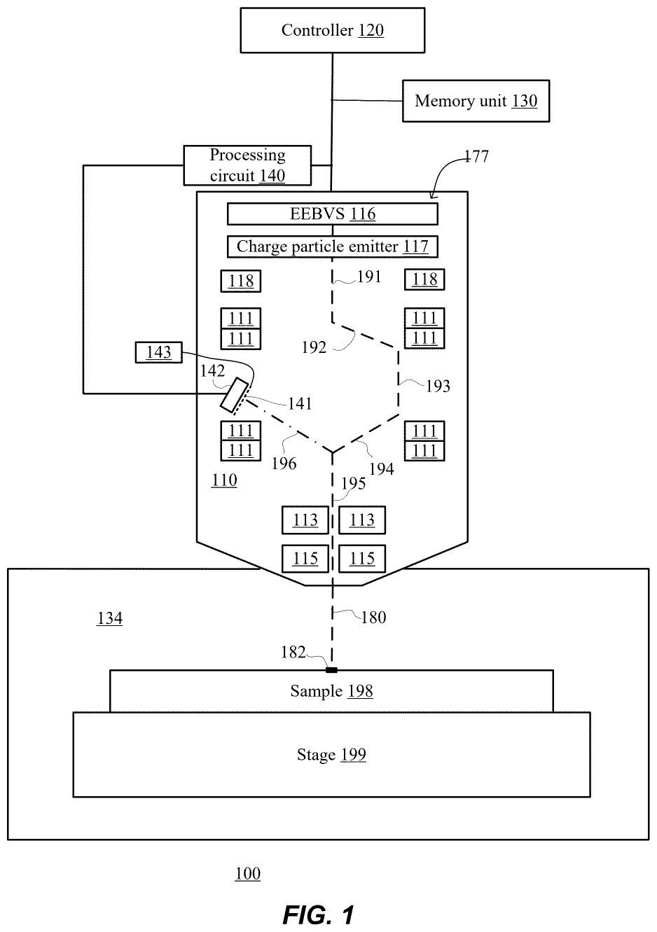

FIG. 1 is an example of charged particle evaluation system 100 and sample 198.

The charged particle evaluation system 100 includes:
a. A column 110.
b. A memory unit 130 for storing instructions and data.
c. A controller 120 that is configured to control the operation of the charged particle evaluation system 100.
d. A sensing unit that includes charged particle detector 142.
e. Energy filter 141 that is configured to selectively allow or prevent charged particles from reaching charged particle detector 142.
f. Energy filter voltage supply unit 143 that is configured to supply an energy filter voltage to the energy filter 141 thereby controlling which charged particles will reach the charged particle detector.
g. Charged particle emitter 117.
h. Charged particle emitter bias voltage supplier 116 (denoted “EEBVS”) configured to supply a charged particle emitter bias voltage to the charged particle emitter 117.
i. A processing circuit 140 that is configured to determine the actual charged particle emitter energy spread and determine the value of a desired value of a charged particle emitter energy bias voltage that once supplied to the charged particle emitter will result in having a desired charged particle emitter energy spread to be shared by charged particle evaluation systems of the group. According to an embodiment, the processing circuit is also configured to generate images based on detection signals from the sensing unit. The processing circuit 140 may include an array of integrated circuits such as graphic processors, general purpose processors, and the like.
j. Optics 177 that is configured to perform evaluations (such as measurements) of a sample, and to measure the charged particle emitter energy spread. The optics 177 includes charged particle emitter 117, the sensing unit, and charged particle beam manipulation components. The optics 177 is configured to propagate a charged particle beam from the charged particle emitter 117 to the sample, to set at least one optical property of the charged particle beam, and to shape and direct charged particles emitted from the sample. According to an embodiment the optics 177 includes the processing circuit 140. According to an embodiment, the optics 177 does not include the processing circuit 140.
k. A vacuum chamber 134 in which the sample is located.
l. A mechanical stage 199 for supporting the sample and moving the sample 198 in order to provide an evaluation result, for example, measure critical dimensions at different measurement sites.

According to an embodiment, the charged particle beam manipulation components include one or more deflection lenses, one or more focusing lenses, charged particle beam collimating optics, charged particle beam shaping optics, and the like. Examples of a column 110 that includes multiple deflection coils for double deflecting a electron beam are illustrated U.S. Pat. No. 7,847,267 of Shemesh et al., which is incorporated herein by reference.

According to an embodiment, the charged particle beam manipulation components include:
a. First deflector 118.
b. Bypass magnetic scan coils 111 that are configured to direct the charged particle beam (during an illumination of the sample) along a bypass path that include first vertical segment 191, first tilted segment 192, second vertical segment 193, second tilted segment 194, and third vertical segment 195. A collection path shared the third vertical segment 195 and also includes a third tilted segment 196.
c. Objective lens 113 that is configured to focus the charged particle beam on the sample 198.
d. Deflector lenses 115 for deflecting the charged particle beam during one or more evaluations, for example, during critical dimension measurements.

The bypass magnetic scan coils 111 are configured to: (i) tilt the charged particle beam 180 that previously propagated along the first vertical segment 191 and along an optical axis, at a first direction to propagate along the first tilted segment 192, (ii) tilt the charged particle beam 180 at an opposite direction such as to propagate along a second vertical segment 193 that is parallel to the first vertical segment 191 but spaced apart from the optical axis, (iii) tilt the charged particle beam at a second direction along the second tilted segment 194, towards the optical axis, and (iv) tilt the charged particle beam at a direction opposing the second direction, such as to propagate along the optical axis and along third vertical segment 195 till impinging on sample 198 and forming spot 182. A system and method for double tilt is described in U.S. Pat. No. 6,674,075 and is incorporated herein by reference.

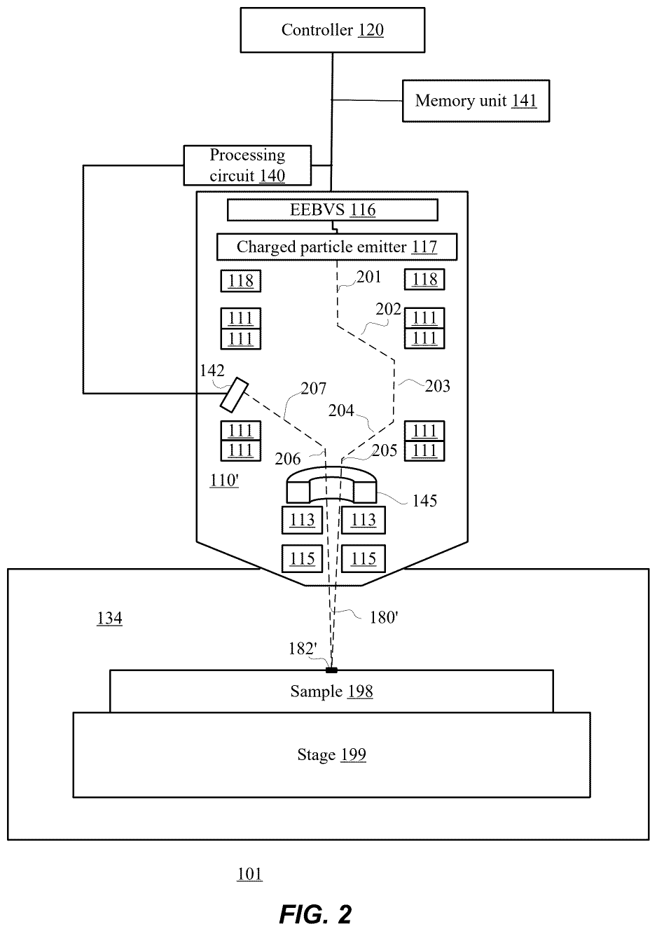

FIG. 2 is an example of a charged particle evaluation system 101 and sample 198.

Charged particle evaluation system 101 of FIG. 2 differs from charged particle evaluation system 100 of FIG. 1 by:
a. Including column 110′ that includes an additional charged particle detector 145 having an aperture through which at least some of the emitted charged particles propagate and reach charged particle detector 142. The aperture may be aligned with the optical axis of the charged particle evaluation system 101. The additional charged particle detector 145 may be included in charged particle evaluation system 100 of FIG. 1.
b. Lacks energy filter in front of additional charged particle detector 145.
c. Uses first deflector 118 to deflect the charged particle beam to provide an out of optical axis charged particle beam 180′ that propagates through an out of optical axis path that is oriented to the path of charged particle beam 180 of FIG. 1 and forms spot 182′ on the sample. The out of optical axis path include out of optical axis segments 201, 202, 203, 204, 205, 206 and 207 that are oriented in relation to corresponding segments: first vertical segment 191, first tilted segment 192, second vertical segment 193, second tilted segment 194, third vertical segment 195 and third tilted segment 196.

The charged particle evaluation system 101 of FIG. 2 is configured to measure the charged particle emitter energy spread by acquiring images of a spot formed on the sample by an out of optical axis charged particle beam at different distances between the sample and the charged particle emitter.

The images may be generated based on readings of at least one out of charged particle detector 142 and additional charged particle detector 145.

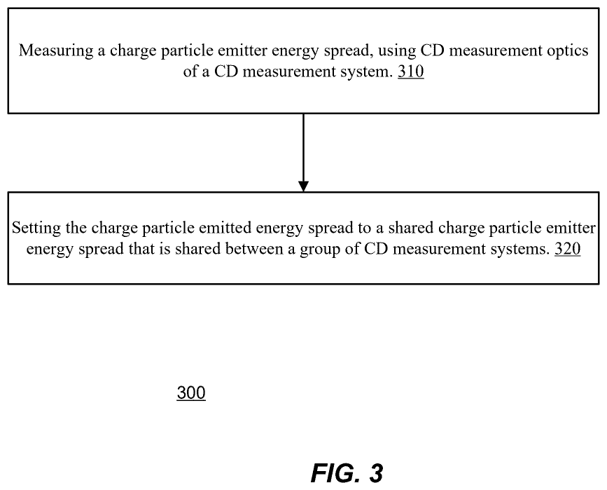

FIG. 3 illustrates an example of method 300 for improving evaluation result matching—such as improving critical dimension (CD) measurements matching.

According to an embodiment, method 300 includes step 310 of measuring a charged particle emitter energy spread, using optics of a charged particle evaluation system, and step 320 of setting the charged particle emitter energy spread to a shared charged particle emitter energy spread that is shared between a group of charged particle evaluation systems.

According to an embodiment, step 310 includes generating a spectrum of charged particle energies emitted by the charged particle emitter, using an energy filter that precedes a charged particle detector configured to detect charged particles emitted from a sample illuminated by charged particles that exhibit the charged particle emitter energy spread.

According to an embodiment, step 310 includes performing multiple evaluation iterations that differ from each other by a value of an energy filter voltage supplied to the energy filter.

According to an embodiment, step 310 includes generating a spectrum of charged particle energies emitted by the charged particle emitter, by performing multiple evaluation iterations that differ from each other by a value of a charged particle emitter bias voltage.

According to an embodiment, step 320 includes setting a value of a charged particle emitter energy bias voltage.

According to an embodiment, step 310 includes acquiring images of a spot formed on the sample by an out of optical axis charged particle beam at different distances between the sample and the charged particle emitter.

According to an embodiment, step 310 includes performing a three-dimensional reconstruction of a proximal end of the out of optical axis charged particle beam.

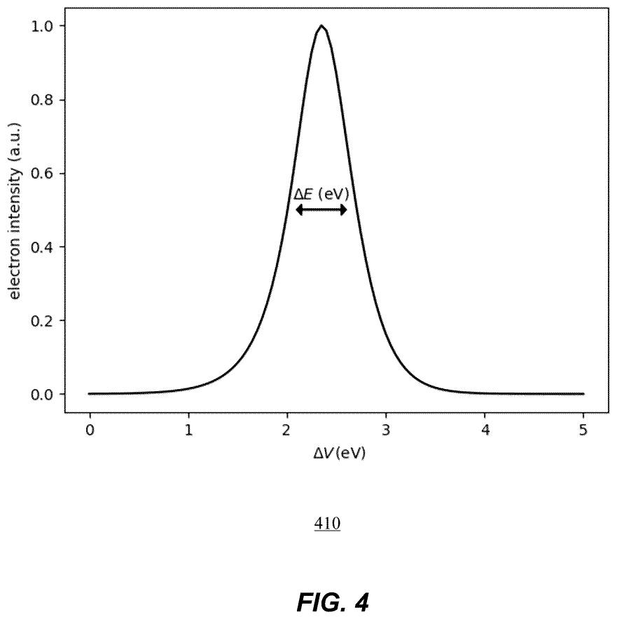

FIG. 4 illustrates an example of a spectrum 410 of charged particle energies emitted by the charged particle emitter. The x-axis represents voltage changes that impact the reception of the charged particles-such as changes in the energy filter voltage or changes in the bias voltage of the charged particle emitter, and the y-axis represents the charged particles intensity. The width of the spectrum at a certain percentile is denoted ΔE and is the charged particle emitter energy spread.

According to an embodiment method 300 also includes performing evaluations-such as critical dimension measurements.

According to an embodiment, the optics is also configured to perform evaluations-such as measure critical dimensions of various measurement sites.

In the foregoing detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using optical and/or electrical components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

Any reference in the specification to a method should be applied mutatis mutandis to a system capable of executing the method and should be applied mutatis mutandis to a computer program product that stores instructions that once executed result in the execution of the method.

Any reference in the specification to a system should be applied mutatis mutandis to a method that may be executed by the system should be applied mutatis mutandis to a computer program product that stores instructions that can be executed by the system.

Any reference in the specification to a computer program product should be applied mutatis mutandis to a method that may be executed when executing instructions stored in the computer program product and should be applied mutandis to a system that is configured to executing instructions stored in the computer program product.

The term and/or means additionally or alternatively. For example, A and/or B means only A, or only B or A and B.

An examples of a critical dimension scanning charged particle microscopes includes the VERITYSEM™ of APPLIED MATERIALS™. Additional critical dimension scanning charged particle microscope manufacturers include HITACHI™ of Tokyo, Japan, or KLA™ Corporation of Milpitas, California.

In the foregoing specification, the embodiments of the disclosure have been described with reference to specific examples of embodiments. It will, however, be evident that various modifications and changes may be made therein without departing from the broader spirit and scope of the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the disclosure described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any reference to the term “comprising” or “having” or “including” should be applied mutatis mutandis to “consisting” and additionally or alternatively should be applied mutatis mutandis to “consisting essentially of.”

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also, for example, the examples, or portions thereof, may implemented as soft or code representations of physical circuitry or of logical representations convertible into physical circuitry, such as in a hardware description language of any appropriate type.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A charged particle evaluation system, comprising:
a controller;
a charged particle emitter configured to emit charged particles that exhibit a charged particle emitter energy spread; and
optics configured to perform evaluations of a sample, and to measure the charged particle emitter energy spread; and
wherein the controller is configured to set the charged particle emitter energy spread to a shared charged particle emitter energy spread that is shared between a group of charged particle evaluation systems.

2. The charged particle evaluation system of claim 1, wherein:
the optics comprise a charged particle detector and an energy filter that precedes the charged particle detector, and
the optics are configured to generate a spectrum of charged particle energies emitted by the charged particle emitter, based on charged particles that were emitted from a sample illuminated by charged particles that exhibit the charged particle emitter energy spread and detected by the charged particle detector.

3. The charged particle evaluation system of claim 2, wherein the charged particle evaluation system is configured to generate the spectrum by performing multiple evaluation iterations that differ from each other by a value of an energy filter voltage supplied to the energy filter.

4. The charged particle evaluation system of claim 2, further comprising a charged particle emitter bias voltage supplier, wherein the charged particle evaluation system is configured to generate the spectrum by performing multiple evaluation iterations that differ from each other by a value of a charged particle emitter bias voltage supplied by the charged particle emitter bias voltage supplier.

5. The charged particle evaluation system according to claim 1, further comprising a charged particle emitter bias voltage supplier that is configured to set the charged particle emitter energy spread by setting a value of a charged particle emitter energy bias voltage supplied by the charged particle emitter bias voltage supplier.

6. The charged particle evaluation system according to claim 1, further comprising a deflector that is configured to deflect a charged particle beam that comprises charged particles emitted by the charged particle emitter to provide an out of optical axis charged particle beam, wherein the charged particle evaluation system is configured to measure of the charged particle emitter energy spread by acquiring images of a spot formed on the sample by an out of optical axis charged particle beam at different distances between the sample and the charged particle emitter.

7. The charged particle evaluation system according to claim 6, further comprising a processing circuit that is configured to perform a three-dimensional reconstruction of a proximal end of the out of optical axis charged particle beam.

8. A method for improving evaluation results matching, the method comprising:
measuring a charged particle emitter energy spread, using optics of a charged particle evaluation system; and
setting the charged particle emitter energy spread to a shared charged particle emitter energy spread that is shared between a group of charged particle evaluation systems.

9. The method of claim 8, wherein the measuring of the charged particle emitter energy spread comprises generating a spectrum of charged particle energies emitted by the charged particle emitter, using an energy filter that precedes a charged particle detector configured to detect charged particles emitted from a sample illuminated by charged particles that exhibit the charged particle emitter energy spread.

10. The method of claim 9, wherein the generating of the spectrum comprises performing multiple evaluation iterations that differ from each other by a value of an energy filter voltage supplied to the energy filter.

11. The method of claim 8, wherein the measuring of the charged particle emitter energy spread comprises generating a spectrum of charged particle energies emitted by the charged particle emitter, by performing multiple evaluation iterations that differ from each other by a value of a charged particle emitter bias voltage.

12. The method according to claim 8, wherein the setting of the charged particle emitter energy spread comprises setting a value of a charged particle emitter energy bias voltage.

13. The method according to claim 8, wherein the measuring of the charged particle emitter energy spread comprises acquiring images of a spot formed on a sample by an out of optical axis charged particle beam at different distances between the sample and the charged particle emitter.

14. The method according to claim 13, further comprising three-dimensional reconstruction of a proximal end of the out of optical axis charged particle beam.

15. A non-transitory computer readable medium for improving evaluation results matching, the non-transitory computer readable medium stores instructions that once executed by a processing circuit of a charged particle evaluation system, causes the charged particle evaluation system to:
measure a charged particle emitter energy spread, using optics of the charged particle evaluation system; and
set a charged particle emitter energy spread to a shared charged particle emitter energy spread that is shared between a group of charged particle evaluation systems.
